(19) United States
(12) Patent Application Publication
(10) Pub. No.: US 2026/0316516 A1
(43) Pub. Date: Oct. 15, 2026

(54) ELECTRIC COMPRESSOR FOR A HEAT MANAGEMENT SYSTEM

(71) Applicant: BorgWarner Inc., Auburn Hills, MI (US)

(72) Inventors: Thomas GLAß, Rockenhausen (DE); Ralf CHRISTMANN, Kaiserslautern (DE)

(21) Appl. No.: 19/428,065

(22) Filed: Dec. 19, 2025

(30) Foreign Application Priority Data
Dec. 20, 2024 (DE) 10 2024 139 499.4

(51) Int. Cl. B60H 1/00; B60H 1/22; B60H 1/32; B60L 1/00; B60L 1/02

(52) U.S. Cl. CPC B60H 1/00314; B60H 1/00278; B60H 1/2218; B60H 1/2221; B60H 1/3226; B60L 1/003; B60L 1/02; B60H 2001/00307

(57) ABSTRACT

The present disclosure relates to an electric compressor (100) for a thermal management system (1) of an automotive application with a vehicle battery. The electric compressor (100) comprises a housing (102), a refrigerant path (111), a coolant heating path (123) and an electric heater (120). In addition, the electric compressor (100) comprises an electric motor (112), a compressor wheel (114) and power electronics (116), which are located in the housing (102). The power electronics (116) are designed to control the electric motor (112) for the purpose of driving the compressor wheel (114). The refrigerant path (111) extends through the housing (102) and is fluidically connected to the compressor wheel (114). In addition, the refrigerant path (111) can be fluidically connected to a refrigerant circuit (30) of the thermal management system (1). The coolant heating path (123) extends through the housing (102) and can be fluidically connected to a coolant circuit (20) of the thermal management system (1). The electric heater (120) is located in the housing (102) and is thermally coupled to the coolant heating path (123). In addition, the electric heater (120) is electrically integrated in the power electronics (116) of the electric compressor (100).

### TECHNICAL FIELD

The present disclosure relates to an electric compressor for a thermal management system in an automotive application. In particular, the present disclosure relates to a thermal management system comprising a corresponding electric compressor. In addition, the present disclosure relates to methods for operating such a thermal management system in a heating mode.

### BACKGROUND

Thermal management systems have been used for many years in various vehicle types. A thermal management system generally comprises a coolant circuit for cooling vehicle subsystems, such as a vehicle battery, and a refrigerant circuit for regulating the temperature in the vehicle interior. The refrigerant circuit can function for example in accordance with the principles of a reversible heat pump. This makes it possible both to heat and provide air conditioning for, i.e. cool, the interior of the vehicle. It is known practice to thermally couple the coolant circuit and the refrigerant circuit via a heat exchanger. Electric vehicles, which can include fully electric vehicles (EV), plug-in hybrid vehicles (PHEV) or hybrid vehicles (HEV), require a vehicle battery in order to supply current to the electric drivetrain of the vehicle. One challenge faced by thermal management systems for electric vehicles consists in regulating the temperature of the vehicle battery in all operating conditions, including a variety of ambient conditions. For example, the temperature of the vehicle battery should not fall below a lower operating-temperature limit in the case of cold ambient temperatures, e.g. in winter. Therefore, it is known practice to arrange an electric heater in the coolant circuit, the vehicle battery being thermally coupled to the coolant circuit, in order to increase the battery temperature. Such additional electric heaters increase the complexity and size of thermal management systems.

The object of the present disclosure is to provide an improved thermal management system of reduced complexity.

### SUMMARY OF THE INVENTION

The present invention relates to an electric compressor as described in claim 1. The invention further relates to a thermal management system comprising such an electric compressor as described in claim 10. In addition, the present invention relates to methods for operating such a thermal management system in a heating mode as described in claim 14.

In a first aspect, the present invention relates to an electric compressor for a thermal management system of an automotive application with a vehicle battery. The electric compressor comprises a housing, a refrigerant path, a coolant heating path and an electric heater. In addition, the electric compressor comprises an electric motor, a compressor wheel and power electronics, which are located in the housing. The power electronics are designed to control the electric motor for the purpose of driving the compressor wheel. The refrigerant path extends through the housing and is fluidically connected to the compressor wheel. In addition, the refrigerant path can be fluidically connected to a refrigerant circuit of the thermal management system. The coolant heating path extends through the housing and can be fluidically connected to a coolant circuit of the thermal management system. The electric heater is located in the housing and is thermally coupled to the coolant heating path. In addition, the electric heater is electrically integrated in the power electronics of the electric compressor. “Electrically integrated” can be understood as meaning that the electric heater is electrically connected to the power electronics and the power electronics are designed to control the electric heater. Integrating the electric heater in the electric compressor makes it possible to reduce the structural space requirement of the electric heating system, and thus the structural space requirement of the thermal management system. In particular, the outlay and costs in terms of pipework can be reduced. It is possible to improve the sustainability of the overall system, because the material consumption (less need for pipework and electrical wiring) and the parts requirement (just one (single) set of power electronics is sufficient for the control of the electric motor of the electric compressor and the electric heater) can be reduced. It is also possible to reduce an overall weight of the electric heating system. In addition, integrating the electric heater in the electric compressor makes it possible to achieve thermal synergy effects.

In embodiments, the coolant heating path can be thermally coupled to the electric motor. In particular, the coolant heating path can be thermally coupled to the stator of the electric motor. In some embodiments, the coolant heating path can be thermally coupled to the electric motor upstream of the electric heater in the flow direction. Such embodiments allow additional heat from the electric motor for heating the vehicle battery to be fed to the coolant, in particular in a heating mode. In particular, the electric motor can be operated in an inefficient mode, in particular in a maximally inefficient mode, and as a result additional heat can be discharged to the coolant. In particular in a heating mode, such embodiments can contribute to heating the vehicle battery up to operating temperature faster. In addition, such embodiments allow the electric heater to have a smaller size, since the coolant can be already preheated before it is heated further by the electric heater.

In embodiments, the coolant heating path can be thermally coupled to the power electronics. In particular, the coolant heating path can be thermally coupled to the power electronics upstream of the electric heater in the flow direction. As an alternative or in addition, the coolant heating path can be thermally coupled to the power electronics upstream of the electric motor in the flow direction. Such embodiments allow additional heat from the power electronics for heating the vehicle battery to be fed to the coolant, in particular in a heating mode. In particular, the power electronics can be operated in an inefficient mode, in particular in a maximally inefficient mode, and as a result discharge additional heat to the coolant. In particular in a heating mode, such embodiments can contribute to heating the vehicle battery up to operating temperature faster. In addition, such embodiments allow the electric heater to have a smaller size, since the coolant can be already preheated before it is heated further by the electric heater.

In embodiments in which the coolant heating path is thermally coupled to the power electronics and the electric motor, the coolant heating path can be arranged and designed in such a way that the power electronics, the electric motor and the electric heater are thermally coupled to the coolant heating path one after another in the flow direction. In embodiments, the thermal coupling can be implemented for example via heat exchangers, such as cooling plates, cooling ribs and/or cooling ducts. For example, respective heat exchangers can be located between the coolant heating path and the power electronics, the electric motor and the electric heater in each case, and have coolant flowing around or through them during operation.

In embodiments, the refrigerant path can be thermally coupled to the electric motor. In particular, the refrigerant path can be thermally coupled to the stator of the electric motor. In particular, the refrigerant path can be thermally coupled to the electric motor upstream of the compressor wheel in the flow direction. Such embodiments allow additional heat from the electric motor for heating the vehicle interior to be fed to the refrigerant in a heating mode. In addition, the electric motor, in particular the stator thereof, can be cooled by the extraction of heat (both in heating mode and in cooling mode).

In embodiments, the refrigerant path can be thermally coupled to the power electronics. In particular, the refrigerant path can be thermally coupled to the power electronics upstream of the compressor wheel in the flow direction. As an alternative or in addition, the refrigerant path can be thermally coupled to the power electronics upstream of the electric motor in the flow direction. In particular, the refrigerant path can be thermally coupled switchably to the power electronics. For example, the refrigerant path can bypass the power electronics via a switchable bypass line. Such embodiments allow additional heat from the power electronics for heating the vehicle interior to be fed to the refrigerant in a heating mode. A switchable coupling makes it possible to prevent or at least reduce an additional input of heat by the power electronics in a cooling mode.

In embodiments, the refrigerant path can be thermally coupled to the electric heater. In particular, the refrigerant path can be thermally coupled to the electric heater upstream of the compressor wheel in the flow direction. In alternative embodiments, the refrigerant path can be thermally coupled to the electric heater downstream of the compressor wheel in the flow direction. In particular, the refrigerant path can be thermally coupled switchably to the electric heater. For example, the refrigerant path can bypass the electric heater via a switchable bypass line. Such embodiments allow additional heat from the electric heater for heating the vehicle interior to be fed to the refrigerant in a heating mode. A switchable coupling makes it possible to prevent or at least reduce an additional input of heat by the electric heater in a cooling mode.

In embodiments in which the refrigerant path is thermally coupled to the electric motor, the power electronics and the electric heater, the refrigerant path can be arranged and designed in such a way that the power electronics, the electric motor and the electric heater are thermally coupled to the refrigerant path one after another in the flow direction. The compressor wheel can in this case be located upstream or downstream of the electric heater in the refrigerant path in the flow direction. In embodiments, the thermal coupling can be implemented for example via heat exchangers, such as cooling plates, cooling ribs and/or cooling ducts. For example, respective heat exchangers can be located between the refrigerant path and the power electronics, the electric motor and the electric heater in each case, and have refrigerant flowing around or through them during operation.

In embodiments, the refrigerant path can extend from a refrigerant path inlet on the housing to a refrigerant path outlet on the housing. In particular, the refrigerant path can be fluidically connectable to the refrigerant circuit of the thermal management system via the refrigerant path inlet and the refrigerant path outlet.

In embodiments, the coolant heating path can extend from a coolant heating path inlet on the housing to a coolant heating path outlet on the housing. In particular, the coolant heating path can be fluidically connectable to the coolant circuit of the thermal management system via the coolant heating path inlet and the coolant heating path outlet.

In embodiments, the power electronics can be designed to operate the electric heater in a heating mode and to operate the electric motor in a low-efficiency mode or a high-efficiency mode, wherein the electric motor generates more waste heat in the low-efficiency mode than in the high-efficiency mode. The low-efficiency mode can be understood as meaning a mode of the electric motor in which the electric motor is selectively activated in such a way that it does not rotate or does not rotate efficiently and thus more waste heat is generated in the stator coils than in a normal mode. This can be implemented for example by energizing the stator coils with direct current or by energizing each phase of the stator coils with the same AC signal. The effective value of the current can also be increased by deliberately feeding in reactive power, in order to increase the ohmic losses. The stator laminated core and the rotor can additionally be heated by deliberately feeding in harmonics. The term “high-efficiency mode” can be understood as meaning that the electric motor is operated with the best possible control (for example optimum, field-oriented control of the motor). For example, the harmonic component can be kept as low as possible. For example, the current can be regulated in such a way that a minimal reactive power is fed in.

In embodiments, the power electronics can be designed to operate the electric motor in the low-efficiency mode when a temperature of a coolant in the coolant heating path lies below a first temperature threshold value. In embodiments, the first temperature threshold value may lie in a range from −10 °C to +5 °C. In particular, the first temperature threshold value may lie in a range from −5 °C to 0 °C. In embodiments, the temperature can be measured via a sensor for example at a coolant heating path inlet of the coolant heating path which leads into the housing. In embodiments, the power electronics can be designed to operate the electric motor in the high-efficiency mode when the temperature of the coolant reaches the first temperature threshold value.

In embodiments, the power electronics can be designed to stop the operation of the electric heater when the temperature of the coolant reaches a second temperature threshold value. The second temperature threshold value can be higher than the first temperature threshold value. In particular, the second temperature threshold value can correspond to a predefined operating temperature of the vehicle battery. In embodiments, the second temperature threshold value may lie in a range from 5 °C to 35 °C. In particular, the second temperature threshold value can lie in a range from 10 °C to 30 °C or in a range from 20 °C to 30 °C. In some embodiments, the operating temperature of the vehicle battery may lie for example in a range from 10 °C to 50 °C, in particular in a range from 15 °C to 45 °C.

In embodiments, the electric heater can be a high-voltage heater. For example, the electric heater can be operable with voltages of at least 240 V. In some configurations, the high-voltage heater can be operable with a voltage of 240 V to 950 V.

In embodiments, the electric motor can be a high-voltage electric motor. For example, the electric motor can be operable with voltages of at least 240 V. In some configurations, the high-voltage electric motor can be operable with a voltage of 240 V to 950 V.

In a second aspect, the present invention relates to a thermal management system for an automotive application with a vehicle battery. The thermal management system comprises an electric compressor as per any embodiment of the first aspect. In addition, the thermal management system comprises a coolant circuit, a refrigerant circuit and a refrigerant/coolant heat exchanger. The vehicle battery is located in the coolant circuit. The coolant heating path is located in the coolant circuit. The coolant circuit comprises a pump which can be used to circulate coolant through the coolant circuit during operation. The refrigerant path is located in the refrigerant circuit. The electric compressor can be used to circulate refrigerant through the refrigerant circuit during operation. The coolant circuit and the refrigerant circuit are thermally coupled via the refrigerant/coolant heat exchanger.

In embodiments of the thermal management system, the coolant heating path can be fluidically decouplable from the coolant circuit switchably via a heater inlet valve. In some embodiments, a heater outlet valve can be provided.

In embodiments of the thermal management system, the coolant circuit can be designed to control the temperature of the vehicle battery.

In embodiments of the thermal management system, the refrigerant circuit can comprise an internal heat exchanger, an expansion device, an external heat exchanger and a switching device. In embodiments, the internal heat exchanger can be thermally couplable to a vehicle interior of the automotive application in order to control the temperature of the vehicle interior. In embodiments, the switching device can be designed to switch the refrigerant circuit between a heating mode and a cooling mode.

In embodiments of the thermal management system, the automotive application can be an electric vehicle. In particular, the automotive application can be a passenger car (automobile), a truck (heavy goods vehicle) or a bus.

In a third aspect, the present invention relates to a method for operating a thermal management system as per the second aspect. If a temperature of the vehicle battery is lower than a predefined operating temperature, the thermal management system is operated in a heating mode and the method comprises the following steps. Determining a temperature of the coolant in the coolant circuit. Operating the thermal management system in a first heating mode when the temperature of the coolant lies below a first temperature threshold value. The first heating mode comprises operating the coolant circuit so that coolant flows through the vehicle battery and the coolant heating path. The first heating mode further comprises operating the electric heater. In addition, the first heating mode comprises operating the electric motor in a low-efficiency mode. The method further comprises operating the thermal management system in a second heating mode when the temperature of the coolant reaches the first temperature threshold value. The second heating mode comprises operating the coolant circuit so that coolant flows through the vehicle battery and the coolant heating path. The second heating mode further comprises operating the electric heater. In addition, the second heating mode comprises operating the electric motor in a high-efficiency mode. The method further comprises ending the heating mode when the temperature of the coolant reaches a second temperature threshold value. The second temperature threshold value is higher than the first temperature threshold value. The second temperature threshold value corresponds to the operating temperature of the vehicle battery.

In embodiments of the method, the determining of the temperature of the coolant can be carried out at predetermined time intervals.

In embodiments of the method, the thermal management system can be operated in a normal mode after the ending of the heating mode. The normal mode can be either a heating mode or a cooling mode. The normal mode can comprise operating the electric motor in a high-efficiency mode.

In embodiments of the method, it is possible for the electric heater to not be operated in the normal mode. In other words, the electric heater can be deactivated in the normal mode.

In embodiments of the method, it is possible to switch from the normal mode to the heating mode when the temperature of the vehicle battery is lower than the predefined operating temperature.

In a fourth aspect, the present disclosure relates to an automotive application with a vehicle battery. The automotive application comprises a thermal management system as per any embodiment of the second aspect. In embodiments, the automotive application can be an electric vehicle. In particular, the automotive application can be a passenger car (automobile), a truck (heavy goods vehicle) or a bus.

### BRIEF DESCRIPTION OF THE FIGURES

Further features are apparent from the accompanying drawings which form part of this disclosure. The drawings are intended to be used to further explain the present disclosure and to enable a person skilled in the art to put the present disclosure into practice. However, the drawings should be understood as non-limiting examples. Common reference numerals in different figures indicate the same or similar features.

FIG. 1a shows a schematic thermal management system, with the refrigerant circuit in a heating mode;

FIG. 1b shows the schematic thermal management system from FIG. 1a, with the refrigerant circuit in a cooling mode;

FIG. 2 shows a schematic thermal management system as per the second aspect of the present invention, with the refrigerant circuit in a heating mode;

FIG. 3a shows a schematically greatly simplified electric compressor as per the first aspect of the present invention in a first exemplary embodiment;

FIG. 3b shows a schematically greatly simplified electric compressor as per the first aspect of the present invention in a second exemplary embodiment;

FIG. 4 shows a flow diagram of the method as per the third aspect of the present invention.

### DETAILED DESCRIPTION

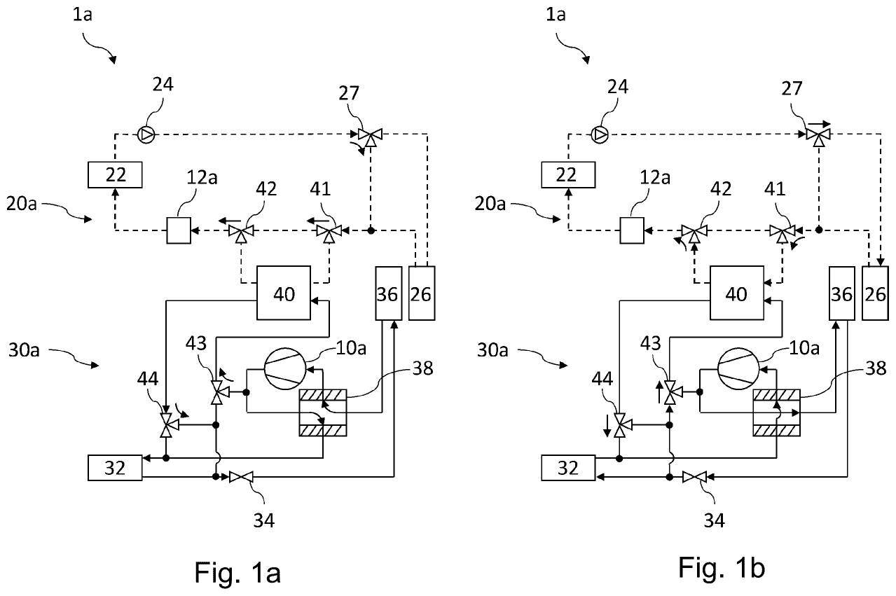

FIGS. 1a and 1b show in general a thermal management system la for an automotive application comprising a coolant circuit 20a, a refrigerant circuit 30a and a refrigerant/coolant heat exchanger 40.

The term “automotive application” may comprise in particular road vehicles, rail vehicles, water vehicles and/or aircraft. In particular, the thermal management system 1 can be designed for use in road vehicles. The term “road vehicles” comprises not only passenger cars (automobiles), but also trucks (heavy goods vehicles) and/or buses. The term “electric vehicle” comprises at least road vehicles such as passenger cars, trucks and buses. In addition, for the purposes of this description, fully electric vehicles (vehicles driven only by electric motor) and hybrid vehicles (vehicles driven by an internal combustion engine plus an electric motor) with or without a plug-in feature (plug for connecting up the vehicle battery to a power supply grid) fall under the term “electric vehicle”. Electric vehicles require a vehicle battery, in order to supply current to the electric drivetrain of the vehicle. Although the following description consistently refers to electric vehicles, it should be understood that the present disclosure can also be used with other automotive applications. In some alternative embodiments, the electric compressor 100 and the thermal management system 1 can also be used in stationary applications.

The coolant circuit 20a is illustrated with dashed lines by way of example and is used to cool vehicle subsystems. A vehicle battery 22, located in the coolant circuit 20a, of the electric vehicle is illustrated by way of example. It should be understood that further vehicle subsystems, such as a traction motor of the electric vehicle and/or power electronics of the traction motor, can be located in the coolant circuit 20a. The coolant circuit 20a can be operated via a pump 24, which circulates coolant through the coolant circuit 20a during operation. The coolant circuit 20a can, as illustrated, further comprise a radiator 26, which acts as an external heat exchanger. In addition, heat can be extracted from the coolant by the radiator 26 and/or by the refrigerant/coolant heat exchanger 40, in order to cool the vehicle subsystems during operation. For example via a coolant inlet valve 41 and/or a coolant outlet valve 42, the refrigerant/coolant heat exchanger 40 can be connected to the coolant circuit 20a, the coolant flow to the refrigerant/coolant heat exchanger 40 can be throttled, or the refrigerant/coolant heat exchanger 40 can be bypassed. The valves 41, 42 can be in the form for example of a 3-way valve. By way of example, additionally illustrated is a radiator valve 27 via which the radiator 26 can be connected to the coolant circuit 20a, the coolant flow to the radiator 26 can be throttled or the radiator 26 can be bypassed. In other words, the valves 27, 41, 42 can control the respective flow of coolant into the adjacent paths and components (such as the radiator 26) of the coolant circuit 20a that are located in those paths. It should be understood that the coolant circuit 20a can comprise further components such as coolant lines, paths, valves, control units. Some of the components illustrated may also be in a different form or not be present in the coolant circuit 20a.

FIGS. 1a and 1b illustrate the refrigerant circuit 30a with solid lines by way of example. The refrigerant circuit 30a is used to regulate the temperature (heating or cooling) in a vehicle interior (i.e. the vehicle cabin, in which the occupants of the vehicle are located) of the electric vehicle. The refrigerant circuit 30a comprises a compressor 10a, an internal heat exchanger 32, an expansion device 34, an external heat exchanger 36 and a switching device 38. The compressor 10a may be in the form in particular of an electric compressor 10a and comprise the compressor components necessary for this, these components being located in a compressor housing of the electric compressor 10a. For example, the compressor components can comprise a compressor wheel, an electric motor and power electronics. The electric motor can be coupled to the compressor wheel for conjoint rotation, for the purpose of driving the latter. The power electronics can be designed to control the electric motor for the purpose of driving the compressor wheel. In addition, the refrigerant circuit 30a can comprise a refrigerant inlet valve 43 and/or a refrigerant outlet valve 44 via which the refrigerant/coolant heat exchanger 40 can be connected to the refrigerant circuit 30a, the refrigerant flow to the refrigerant/coolant heat exchanger 40 can be throttled, or the refrigerant/coolant heat exchanger 40 can be bypassed. In exemplary embodiments, the refrigerant inlet valve 43 and/or the refrigerant outlet valve 44 can be in the form of a 3-way valve. The refrigerant circuit 30a can be operated via the electric compressor 10a, which circulates refrigerant through the refrigerant circuit 30a during operation. The internal heat exchanger 32 is thermally coupled to the vehicle interior and is thus designed to heat or cool the vehicle interior depending on the mode of operation. The switching device 38 can be used to switch the refrigerant circuit 30a between a heating mode (FIG. 1a) and a cooling mode (FIG. 1b).

In this respect, FIG. 1a shows a heating mode. Refrigerant is expanded (and cooled in the process) by the expansion device 34. Heat can be fed to the refrigerant via the external heat exchanger 36. Subsequently, the refrigerant is compressed (and heated in the process) by the electric compressor 10a. The heated refrigerant can then be fed to the internal heat exchanger 32 and as a result the vehicle interior can be heated. In addition, the heated refrigerant, as illustrated in FIG. 1a, can be fed to the refrigerant/coolant heat exchanger 40 via the refrigerant inlet valve 43. As an alternative, the refrigerant inlet valve 43 could also be blocked so that the heated refrigerant is conducted exclusively to the internal heat exchanger 32. The refrigerant outlet valve 44 can also be blocked so that, at the node directly upstream of the internal heat exchanger 32 in the flow direction, no refrigerant flows in the direction toward or through the refrigerant outlet valve 44. In heating mode, the internal heat exchanger 32 can thus act as a condenser and the external heat exchanger 36 as an evaporator. In alternative embodiments, the internal heat exchanger 32 and/or the external heat exchanger 36 may each comprise a condenser and an evaporator, which are switched on or off accordingly depending on the mode of operation.

In the case of cold ambient conditions, it may be necessary to heat up the vehicle battery, in particular when starting the electric vehicle. Accordingly, as illustrated in FIG. 1a, coolant circulating through the coolant circuit 20a can be heated to operating temperature by the electric heater 12a. In the process, in particular the radiator in the coolant circuit 20a can be bypassed (for example by correspondingly switching the radiator valve 27 as shown in FIG. 1a). In particular, if the refrigerant cannot yet feed sufficient heat to the coolant, the refrigerant/coolant heat exchanger 40 in the coolant circuit 20a can be bypassed (for example by correspondingly switching the coolant inlet valve or coolant outlet valve 41, 42 as illustrated in FIG. 1a). In order to increase the heating output, at a correspondingly sufficiently high temperature of the heated refrigerant, the coolant inlet valve 41 and the coolant outlet valve 42 can be switched in such a way that an exchange of heat takes place at the refrigerant/coolant heat exchanger 40. As soon as the vehicle battery 22 reaches a desired operating temperature, the electric heater can be deactivated. In other words, a heating mode of the coolant circuit 20a is ended. In addition, the coolant inlet valve 41 and the coolant outlet valve 42 can be returned to the position as shown in FIG. 1a. Furthermore, the radiator valve 27 can be switched in such a way that coolant flows through the radiator and the coolant circuit 20a can be used during operation of the vehicle to cool the vehicle battery 22 and any further vehicle subsystems (e.g. traction motor and the power electronics thereof), which are not depicted.

FIG. 1b shows the thermal management system la in a cooling mode. Refrigerant is compressed by the electric compressor 10a (and heated in the process). Heat can be extracted from the refrigerant via the external heat exchanger 36. Subsequently, the refrigerant is expanded (and cooled in the process) by the expansion device 34. The cooled refrigerant can then be fed to the internal heat exchanger 32 and as a result the vehicle interior can be cooled. In addition, the cooled refrigerant, as illustrated in FIG. 1b, can be fed to the refrigerant/coolant heat exchanger 40 via the refrigerant inlet valve 43. It should be understood that the refrigerant inlet valve 43 is blocked for refrigerant flowing directly from the electric compressor 10a. Furthermore, it should be understood that the valve branch of the refrigerant outlet valve 44 that is on the right in FIG. 1b is blocked for refrigerant flowing from the expansion device 34. As an alternative, the refrigerant inlet valve 43 could also be blocked so that the cooled refrigerant is conducted exclusively to the internal heat exchanger 32 (i.e. bypassing the refrigerant/coolant heat exchanger 40). The refrigerant outlet valve 44 can also be blocked so that, at the node directly downstream of the internal heat exchanger 32 in the flow direction, no refrigerant flows in the direction toward and through the refrigerant outlet valve 44. In cooling mode, the internal heat exchanger 32 can thus act as an evaporator and the external heat exchanger 36 as a condenser. In alternative embodiments, the internal heat exchanger 32 and/or the external heat exchanger 36 may each comprise a condenser and an evaporator, which are switched on or off accordingly depending on the mode of operation.

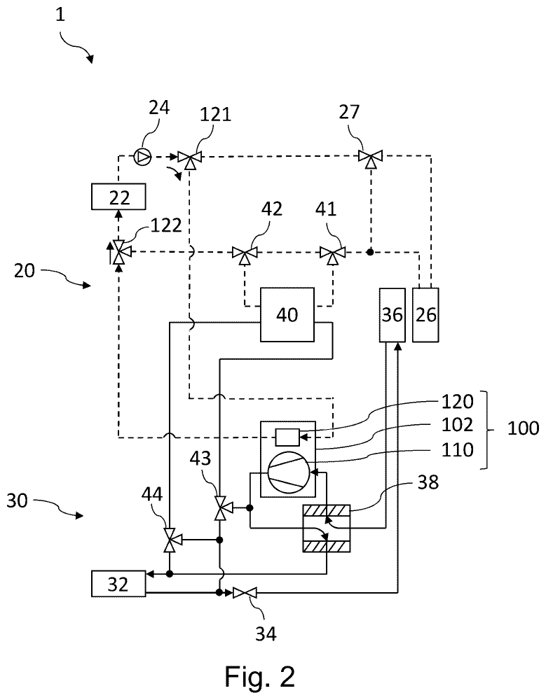

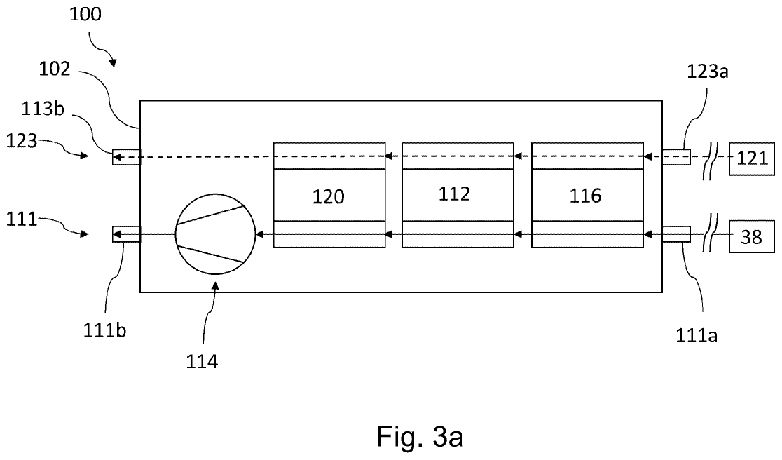

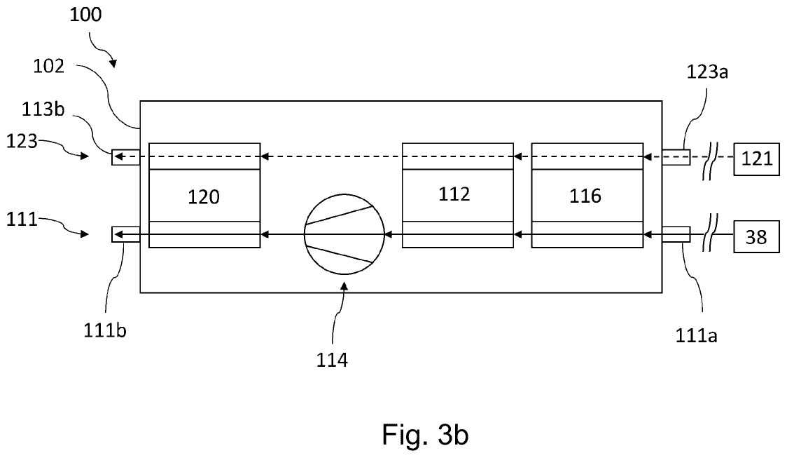

By contrast to the thermal management system la described in general with reference to FIG. 1a and 1b, the thermal management system 1 according to the invention comprises, as per the second aspect of the present invention (see FIG. 2), an electric compressor 100 which has an integrated electric heater 120 and an integrated coolant heating path 123 as per the first aspect of the present invention (see FIGS. 3a and 3b). Otherwise, the functionalities and components of the thermal management system 1 can be at least partially the same or similar to the thermal management system 1a described in general above.

With reference to FIG. 2, the thermal management system 1 for an electric vehicle with a vehicle battery 22 as per the second aspect of the present invention is schematically illustrated. Besides the electric compressor 100, the thermal management system 1 comprises a coolant circuit 20, a refrigerant circuit 30 and a refrigerant/coolant heat exchanger 40. The vehicle battery 22 is located in the coolant circuit 20.

With reference to FIGS. 2, 3a and 3b, the electric compressor 100 comprises a housing 102, a refrigerant path 111, a coolant heating path 123 and an electric heater 120. In addition, the electric compressor 100 comprises an electric motor 112, a compressor wheel 114 and power electronics 116. The electric motor 112, the compressor wheel 114 and the power electronics 116 are located in the housing 102. The electric motor 112, the compressor wheel 114 and the power electronics 116 can also be referred to collectively as compressor components 110. The power electronics 116 are designed to control the electric motor 112 for the purpose of driving the compressor wheel 114. In some embodiments, the power electronics can comprise at least one control unit and an inverter. The electric motor 112 can in particular comprise a stator and a rotor. The rotor can be coupled to the compressor wheel 114 for conjoint rotation, for the purpose of driving the latter.

The refrigerant path 111 extends through the housing 102 and is fluidically connected to the compressor wheel 114. This means that the compressor wheel 114 is designed to drive refrigerant through the refrigerant path 111 and compress it in the process. In addition, the refrigerant path 111 is fluidically connected or connectable to the refrigerant circuit 30. In other words, the refrigerant path 111 can be understood as being a part of the path of the refrigerant circuit 30 that extends through the housing 102. Expressed differently, the refrigerant path 111 is located in the refrigerant circuit 30. During operation, the electric compressor 100 is designed to circulate refrigerant through the refrigerant circuit 30. The coolant heating path 123 extends through the housing 102 and is fluidically connected or connectable to the coolant circuit 20 of the thermal management system 1. In other words, the coolant heating path 123 can be understood as being a part of the path of the coolant circuit 20 that extends through the housing 102. Expressed differently, the coolant heating path 123 is located in the coolant circuit 20. The electric heater 120 is located in the housing 102 and is thermally coupled to the coolant heating path 123. In other words, the electric heater 120 is located in, i.e. thermally coupled to, the coolant circuit 20. In addition, the electric heater 120 is electrically integrated in the power electronics 116 of the electric compressor 100.

“Electrically integrated” can be understood as meaning that the electric heater 120 is electrically connected to the power electronics 116 and the power electronics 116 are designed to control the electric heater 120.

Because the electric heater 120 is integrated in the electric compressor 100, the electric compressor 100 can also be referred to as an integrated electric compressor 100. The embodiment of the electric compressor as an integrated electric compressor 100 means that the structural space requirement of the electric heater 120, and thus the structural space requirement of the thermal management system 1, can be reduced. In particular, the outlay and costs in terms of pipework can be reduced. It is possible to improve the sustainability of the overall system, because the material consumption (less need for pipework and electrical wiring) and the parts requirement can be reduced. The electric heater 12a of the thermal management system la of FIGS. 1a and 1b, by contrast, represents an independent component which requires an independent housing and independent power electronics. In particular in comparison to the thermal management system la of FIGS. 1a and 1b, just one (single) set of power electronics 116 and one (single) housing 102 is sufficient for the control of the electric motor 112 of the electric compressor 100 and the control of the electric heater 120. It is also possible to reduce an overall weight of the electric heater 120. In addition, integrating the electric heater in the electric compressor makes it possible to achieve thermal synergy effects (during the cooling and/or heating).

Further with reference to FIG. 2, the coolant circuit 20 and the refrigerant circuit 30 can be thermally coupled via the refrigerant/coolant heat exchanger 40. For example, a thermal coupling as explained above in relation to FIGS. 1a and 1b can be controlled analogously via the coolant inlet valve 41, the coolant outlet valve 42, the refrigerant inlet valve 43 and/or the refrigerant outlet valve 44.

As also illustrated in FIG. 2, the thermal management system 1 can comprise a heater inlet valve 121. The heater inlet valve 121 can be formed and located in the coolant circuit 20 such that the coolant heating path 123 can be fluidically decoupled switchably from the coolant circuit 20. In other words, the coolant heating path 123 can be fluidly decoupled from the coolant circuit 20 switchably via the heater inlet valve 121. In some embodiments, alternatively or additionally, a heater outlet valve 122 can be provided. In some embodiments, the heater inlet valve 121 and/or the heater outlet valve 122 can be in the form of a 3-way valve. In alternative embodiments, the coolant circuit 20 can comprise other line portions, paths and/or valves.

The coolant circuit 20 can be designed in particular to control the temperature of the vehicle battery 22. In this case, the coolant circuit 20 can be operable, depending on the mode of operation and requirements, to cool or heat the vehicle battery 22. As already mentioned, further vehicle subsystems or components of the electric vehicle that are to be cooled, such as the traction motor and/or the power electronics of the traction motor, can be located in the coolant circuit 20. As already described, the coolant circuit 20 can further comprise the radiator 26 (which acts as an external heat exchanger). Heat can be extracted from the coolant by the radiator 26 and/or the refrigerant/coolant heat exchanger 40. In addition, the coolant circuit 20 can comprise a pump 24 which is arranged and designed to circulate coolant through the coolant circuit 20 during operation. In other words, the coolant circuit 20 can comprise a pump 24 which can be used to circulate coolant through the coolant circuit 20 during operation.

The refrigerant circuit 30 may comprise, analogously to the refrigerant circuit 30a described above, an internal heat exchanger 32, an expansion device 34, an external heat exchanger 36 and a switching device 38 (see FIG. 2). In embodiments, the internal heat exchanger 32 can be thermally couplable to a vehicle interior of the electric vehicle in order to control the temperature of the vehicle interior. In embodiments, the switching device 38 can be designed to switch the refrigerant circuit 30 between a heating mode and a cooling mode. As described, in the heating mode, the internal heat exchanger 32 can act as a condenser and the external heat exchanger 36 as an evaporator. In cooling mode, the internal heat exchanger 32 can act as an evaporator and the external heat exchanger 36 as a condenser. In alternative embodiments, the internal heat exchanger 32 and/or the external heat exchanger 36 may each comprise a condenser and an evaporator. In such embodiments, the switching device can comprise corresponding valves/lines, which conduct the refrigerant to the evaporator or the condenser in the respective (heating or cooling) mode.

With reference to FIGS. 3a and 3b, the refrigerant path 111 can extend from a refrigerant path inlet 111a on the housing 102 to a refrigerant path outlet 111b on the housing 102. In particular, the refrigerant path 111 can be fluidically connected to the refrigerant circuit 30 of the thermal management system 1 via the refrigerant path inlet 111a and the refrigerant path outlet 111b. The coolant heating path 123 can extend from a coolant heating path inlet 123a on the housing 102 to a coolant heating path outlet 123b on the housing 102. In particular, the coolant heating path 123 can be fluidically connected to the coolant circuit 20 of the thermal management system 1 via the coolant heating path inlet 123a and the coolant heating path outlet 123b. In particular, the coolant heating path 123 can be fluidically connected to the coolant circuit 20 of the thermal management system 1 by a switchable connection (for example via corresponding valves 121, 122).

In some embodiments, the electric heater 120 can be a high-voltage heater. For example, the electric heater 120 can be operable with voltages of at least 240 V. In some configurations, the high-voltage heater can be operable with a voltage of 240 V to 950 V.

In some embodiments, the electric motor 112 can be a high-voltage electric motor. For example, the electric motor 112 can be operable with voltages of at least 240 V. In some configurations, the high-voltage electric motor can be operable with a voltage of 240 V to 950 V.

As illustrated in FIGS. 3a and 3b, in preferred embodiments the coolant heating path 123 can be thermally coupled to the electric motor 112. In particular, the coolant heating path 123 can be thermally coupled to the stator of the electric motor 112. In some embodiments, the coolant heating path 123 can be thermally coupled to the electric motor 112 upstream of the electric heater 120 in the flow direction (of the coolant; i.e. from the coolant heating path inlet 123a to the coolant heating path outlet 123b). Such embodiments allow additional heat from the electric motor 112 for heating the vehicle battery 22 to be fed to the coolant, in particular in a heating mode. In particular, the electric motor 112 can be operated in an inefficient mode, in particular in a maximally inefficient mode, and as a result additional heat can be discharged to the coolant. In particular in a heating mode, such embodiments can contribute to heating the vehicle battery 22 up to operating temperature faster. In addition, such embodiments allow the electric heater 120 to have a smaller size, since the coolant can be already preheated before it is heated further by the electric heater 120.

In embodiments, the coolant heating path 123 can be thermally coupled to the power electronics 116 (see FIGS. 3a and 3b). In particular, the coolant heating path 123 can be thermally coupled to the power electronics 116 upstream of the electric heater 120 in the flow direction (of the coolant; i.e. from the coolant heating path inlet 123a to the coolant heating path outlet 123b). As an alternative or in addition, the coolant heating path 123 can be thermally coupled to the power electronics 116 upstream of the electric motor 112 in the flow direction. Such embodiments allow additional heat from the power electronics 116 for heating the vehicle battery 22 to be fed to the coolant, in particular in a heating mode. In particular, the power electronics 116 can be operated in an inefficient mode, in particular in a maximally inefficient mode, and as a result discharge additional heat to the coolant. In particular in a heating mode, such embodiments can contribute to heating the vehicle battery 22 up to operating temperature faster. In addition, such embodiments allow the electric heater 120 to have a smaller size, since the coolant can be already preheated before it is heated further by the electric heater 120.

In particularly preferred embodiments, the coolant heating path 123 can be thermally coupled to the power electronics 116 and the electric motor 112 (see FIGS. 3a and 3b). In this case, the coolant heating path 123 can be arranged and designed such that the power electronics 116, the electric motor 112 and the electric heater 120 are thermally coupled to the coolant heating path 123 one after another in the flow direction (of the coolant; i.e. from the coolant heating path inlet 123a to the coolant heating path outlet 123b). In other words, the coolant heating path 123 can be configured such that, during operation, coolant flows from the coolant heating path inlet 123a to the coolant heating path outlet 123b and in the process passes through the power electronics 116, the electric motor 112 and the electric heater 120 one after another. In embodiments, the thermal coupling of the coolant heating path 123 can be implemented for example via heat exchangers, such as cooling plates, cooling ribs and/or cooling ducts. For example, respective heat exchangers can be located between the coolant heating path 123 and the power electronics 116, the electric motor 112 and the electric heater 120 in each case, and have coolant flowing around or through them during operation. In some embodiments, the coolant heating path 123 can be thermally couplable switchably to the power electronics 116 and/or the electric motor 112. For example, it is possible to provide corresponding bypass paths with valves, which bypass the power electronics 116 and/or the electric motor 112, i.e. the heat exchangers thereof. In alternative embodiments, it is possible for the coolant heating path 123 to not be thermally coupled to the power electronics 116 and/or the electric motor 112.

This allows the electric compressor 100 to be used for multiple functions. In a heating mode, the electric compressor 100 can be operated to heat the vehicle interior (together with the refrigerant circuit 30) and/or the vehicle battery (together with the coolant circuit 20 via the refrigerant/coolant heat exchanger 40 and/or via the thermal coupling of the coolant heating path 123 to one or more compressor components 110). In a cooling mode, the electric compressor 100 can be operated to cool the vehicle interior. In addition, in cooling mode, the electric compressor 100 together with the refrigerant circuit 30 can extract heat from the coolant circuit 20 via the refrigerant/coolant heat exchanger 40 of the thermal management system 1, in order to cool components of the drive system of the electric vehicle (such as the vehicle battery 22, the traction motor or power electronics of the traction motor). In a cooling mode, the thermal coupling of the coolant heating path 123 to one or more compressor components 110 (in particular the power electronics 116 and/or the electric motor 112) makes it possible to extract heat from the one or more compressor components 110 and thereby cool them. As a result, under certain operating conditions, the coolant heating path 123 can contribute to cooling the compressor components 110.

Further with reference to FIGS. 3a and 3b, the refrigerant path 111 can be thermally coupled to the electric motor 112. In particular, the refrigerant path 111 can be thermally coupled to the stator of the electric motor 112. In particular, the refrigerant path 111 can be thermally coupled to the electric motor 112 upstream of the compressor wheel 114 in the flow direction (of the refrigerant; i.e. from the refrigerant path inlet 111a to the refrigerant path outlet 111b). Such embodiments allow additional heat from the electric motor 112 for heating the vehicle interior to be fed to the refrigerant in a heating mode. In addition, the electric motor 112, in particular the stator thereof, can be cooled by the extraction of heat (both in heating mode and in cooling mode).

In some embodiments, the refrigerant path 111 can be thermally coupled to the power electronics 116 (see FIGS. 3a and 3b). In particular, the refrigerant path 111 can be thermally coupled to the power electronics 116 upstream of the compressor wheel 114 in the flow direction (of the refrigerant; i.e. from the refrigerant path inlet 111a to the refrigerant path outlet 111b). As an alternative or in addition, the refrigerant path 111 can be thermally coupled to the power electronics 116 upstream of the electric motor 112 in the flow direction. In particular, the refrigerant path 111 can be thermally coupled switchably to the power electronics 116. For example, the refrigerant path 111 can bypass the power electronics 116 via a switchable bypass line. Such embodiments allow additional heat from the power electronics 116 for heating the vehicle interior to be fed to the refrigerant in a heating mode. A switchable coupling makes it possible to prevent or at least reduce an additional input of heat by the power electronics 116 in a cooling mode.

In some embodiments, the refrigerant path 111 can be thermally coupled to the electric heater 120 (see FIGS. 3a and 3b). In particular, the refrigerant path 111 can be thermally coupled to the electric heater 120 upstream of the compressor wheel 114 in the flow direction (of the refrigerant; i.e. from the refrigerant path inlet 111a to the refrigerant path outlet 111b). In alternative embodiments, the refrigerant path 111 can be thermally coupled to the electric heater 120 downstream of the compressor wheel 114 in the flow direction (see FIG. 3b). In particular, the refrigerant path 111 can be thermally coupled switchably to the electric heater 120. For example, the refrigerant path 111 can bypass the electric heater 120 via a switchable bypass line. Such embodiments allow additional heat from the electric heater 120 for heating the vehicle interior to be fed to the refrigerant in a heating mode. A switchable coupling makes it possible to prevent or at least reduce an additional input of heat by the electric heater 120 in a cooling mode.

In particularly preferred embodiments, the refrigerant path 111 can be thermally coupled to the electric motor 112, the power electronics 116 and the electric heater 120 (see FIGS. 3a and 3b). In this case, the refrigerant path 111 can be arranged and designed such that the power electronics 116, the electric motor 112 and the electric heater 120 are thermally coupled to the refrigerant path 111 one after another in the flow direction (of the refrigerant; i.e. from the refrigerant path inlet 111a to the refrigerant path outlet 111b). The compressor wheel 114 can in this case be located upstream or downstream of the electric heater 120 in the refrigerant path 111 in the flow direction. In embodiments, the thermal coupling of the refrigerant path 111 can be implemented for example via heat exchangers, such as cooling plates, cooling ribs and/or cooling ducts. For example, respective heat exchangers can be located between the refrigerant path 111 and the power electronics 116, the electric motor 112 and the electric heater 120 in each case, and have refrigerant flowing around or through them during operation. In some embodiments, the refrigerant path 111 can be thermally couplable switchably to the power electronics 116, the electric motor 112 and/or the electric heater 120. For example, it is possible to provide corresponding bypass paths with valves that bypass the power electronics 116, the electric motor 112 and/or the electric heater 120, i.e. the heat exchangers thereof. In alternative embodiments, it is possible for the refrigerant path 111 to not be thermally coupled to the power electronics 116, the electric motor 112 and/or the electric heater 120.

As already described, under cold ambient conditions it can be necessary to heat the vehicle battery 22, in particular when starting the electric vehicle. In such cases, the electric compressor 100 can be operated in a heating mode. In the heating mode, the electric heater 120 is operated. In the heating mode, the electric motor 112 is operated. In particular, the electric motor 112 is operated in a low-efficiency mode or in a high-efficiency mode. In other words, the power electronics 116 are designed to, in a heating mode, operate the electric heater 120 and to operate the electric motor 112 in a low-efficiency mode or a high-efficiency mode. The electric motor 112 generates more waste heat in the low-efficiency mode than in the high-efficiency mode. The low-efficiency mode can be understood as meaning a mode of the electric motor 112 in which the electric motor 112 is selectively activated in such a way that it does not rotate or does not rotate efficiently and thus more waste heat is generated in the stator coils of the stator than in the high-efficiency mode. This can be implemented for example by energizing the stator coils with direct current or by energizing each phase of the stator coils with the same AC signal. The effective value of the current can also be increased by deliberately feeding in reactive power, in order to increase the ohmic losses. A stator laminated core of the stator and the rotor can additionally be heated by deliberately feeding in harmonics. The term “high-efficiency mode” can be understood as meaning that the electric motor 112 is operated with the best possible control (for example optimum field-oriented control of the electric motor 112). For example, the harmonic component can be kept as low as possible. For example, the current can be regulated in such a way that a minimal reactive power is fed in.

In particular, the power electronics 116 can be designed to operate the electric motor 112 in the low-efficiency mode when a temperature T of the coolant in the coolant heating path 123 lies below a first temperature threshold value T1. In embodiments, the first temperature threshold value T1 may lie in a range from −10 °C to +5 °C. In particular, the first temperature threshold value T1 may lie in a range from −5 °C to 0 °C. In embodiments, the temperature T of the coolant can be measured via a sensor for example at the coolant heating path inlet 123a of the coolant heating path 123. In embodiments, the power electronics 116 can be designed to operate the electric motor 112 in the high-efficiency mode when the temperature T of the coolant reaches the first temperature threshold value T1.

The heating mode can be ended when the temperature T of the coolant reaches a second temperature threshold value T2. In other words, the power electronics 116 can be designed to stop the operation of the electric heater 120 when the temperature T of the coolant reaches a second temperature threshold value T2. The second temperature threshold value T2 can be higher than the first temperature threshold value T1. In particular, the second temperature threshold value T2 can correspond to a predefined operating temperature Tdef of the vehicle battery 22. In embodiments, the second temperature threshold value T2 may lie in a range from 5 °C to 35 °C. In particular, the second temperature threshold value T2 can lie in a range from 10 °C to 30 °C or in a range from 20 °C to 30 °C. In some embodiments, the operating temperature of the vehicle battery may lie for example in a range from 10 °C to 50 °C, in particular in a range from 15 °C to 45 °C.

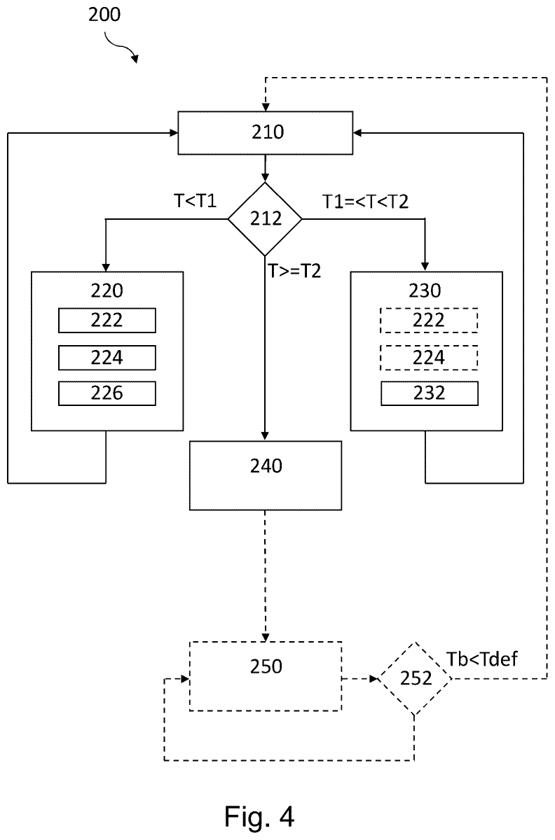

According to the third aspect of the present invention, a method 200 for operating the thermal management system 1 of the second aspect is described. In this respect, FIG. 4 shows a schematic flow diagram of the method 200. Individual or multiple features for the method 200 are therefore also disclosed for the thermal management system 1 and the electric compressor 100, and vice versa.

The method 200 comprises operating the thermal management system 1 in a heating mode when a temperature Tb of the vehicle battery 22 is lower than a predefined operating temperature Tdef. The method 200 further comprises the following steps.

Determining 210 a temperature T of the coolant in the coolant circuit 20. Operating 220 the thermal management system 1 in a first heating mode when the temperature of the coolant lies below a first temperature threshold value T1. Operating 230 the thermal management system 1 in a second heating mode when the temperature of the coolant reaches the first temperature threshold value T1. Ending 240 the heating mode when the temperature of the coolant reaches a second temperature threshold value T2.

As schematically illustrated in FIG. 4, the first heating mode 220 comprises operating 222 the coolant circuit 20 so that coolant flows through the vehicle battery 22 and the coolant heating path 123. The first heating mode further comprises operating 224 the electric heater 120. In addition, the first heating mode comprises operating 226 the electric motor 112 in a low-efficiency mode.

Coolant flowing through the vehicle battery is to be understood as meaning that the coolant flows through a corresponding heat exchanger for thermally coupling the vehicle battery 22 to the coolant circuit 20.

Further with reference to FIG. 4, the second heating mode comprises operating 222 the coolant circuit 20 so that coolant flows through the vehicle battery 22 and the coolant heating path 123. The second heating mode further comprises operating 224 the electric heater 120. In addition, the second heating mode comprises operating 232 the electric motor 112 in a high-efficiency mode.

The second temperature threshold value T2 is higher than the first temperature threshold value T1. The second temperature threshold value T2 corresponds to the operating temperature Tdef of the vehicle battery 22.

In embodiments of the method 200, the determining 210 of the temperature T of the coolant can be carried out at predetermined time intervals. In embodiments, the time intervals can be between 1 ms and 10 s. In embodiments, the temperature T of the coolant can be measured via one or more sensors in the cooling circuit 20. In embodiments, the one or more sensors can be located upstream and/or downstream of the vehicle battery 22 in the flow direction. In some embodiments, the one or more sensors can be located in the vehicle battery 22, and optionally measure the temperature Tb of the vehicle battery 22 itself. The temperature of the coolant can be ascertained on the basis of the temperature Tb of the vehicle battery. In some embodiments, the temperature Tb of the vehicle battery 22 can be ascertained on the basis of the temperature T of the coolant.

In embodiments of the method, the thermal management system 1 can be operated 250 in a normal mode after the ending 240 of the heating mode (see FIG. 4). The normal mode can be either a heating mode or a cooling mode of the electric compressor 100. The normal mode can comprise operating the electric motor 112 in a high-efficiency mode. In normal mode, the coolant circuit 20 is used to cool the vehicle subsystems.

In embodiments of the method, it is possible for the electric heater 120 to not be operated in the normal mode. In other words, the electric heater 120 can be deactivated in the normal mode. At least the coolant heating path 123 can be decoupled from the coolant circuit 20, for example by correspondingly blocking the heater inlet valve 121 and/or the heater outlet valve 122.

In embodiments, it is possible for the electric heater 120 to be operated in normal mode not to heat the vehicle battery 22, but to heat the refrigerant path 111. This can be implemented for example by thermally coupling the electric heater 120 to the refrigerant path 111 and at the same time decoupling the coolant heating path 123 from the coolant circuit 20.

In embodiments of the method 200, it is possible to switch 252 from the normal mode to the heating mode when the temperature Tb of the vehicle battery 22 is lower than the predefined operating temperature Tdef (see FIG. 4).

Although the present invention has been described above and defined in the appended claims, it should be understood that the invention may alternatively also be defined in accordance with the following embodiments:
1. An electric compressor (100) for a thermal management system (1) of an automotive application with a vehicle battery, comprising:
   a housing (102);
   an electric motor (112), a compressor wheel (114) and power electronics (116), which are located in the housing (102), the power electronics (116) being designed to control the electric motor (112) for the purpose of driving the compressor wheel (114);
   a refrigerant path (111), which extends through the housing (102) and is fluidically connected to the compressor wheel (114), wherein the refrigerant path (111) can be fluidically connected to a refrigerant circuit (30) of the thermal management system (1),
   a coolant heating path (123), which extends through the housing (102) and can be fluidically connected to a coolant circuit (20) of the thermal management system (1), and
   an electric heater (120), which is located in the housing (102) and is thermally coupled to the coolant heating path (123),
   wherein the electric heater (120) is electrically integrated in the power electronics (116) of the electric compressor (100).
2. The electric compressor (100) as described in embodiment 1, wherein the coolant heating path (123) is thermally coupled to the electric motor (112).
3. The electric compressor (100) as described in either one of the preceding embodiments, wherein the coolant heating path (123) is thermally coupled to the power electronics (116).
4. The electric compressor (100) as described in embodiments 2 and 3, wherein the coolant heating path (123) is arranged and designed in such a way that the power electronics (116), the electric motor (112) and the electric heater (120) are thermally coupled to the coolant heating path (123) one after another in the flow direction.
5. The electric compressor (100) as described in any one of the preceding embodiments, wherein the refrigerant path (111) is thermally coupled to the electric motor (112).
6. The electric compressor (100) as described in any one of the preceding embodiments, wherein the refrigerant path (111) is thermally coupled to the power electronics (116).
7. The electric compressor (100) as described in any one of the preceding embodiments, wherein the refrigerant path (111) is thermally coupled to the electric heater (120).
8. The electric compressor (100) as described in embodiments 5 to 7, wherein the refrigerant path (111) is arranged and designed in such a way that the power electronics (116), the electric motor (112) and the electric heater (120) are thermally coupled to the refrigerant path (111) one after another in the flow direction, the compressor wheel (114) being arranged upstream or downstream of the electric heater (120) in the refrigerant path (111) in the flow direction.
9. The electric compressor (100) as described in any one of the preceding embodiments, wherein the refrigerant path (111) extends from a refrigerant path inlet (111a) on the housing (102) to a refrigerant path outlet (111b) on the housing (102).
10. The electric compressor (100) as described in any one of the preceding embodiments, wherein the coolant heating path (123) extends from a coolant heating path inlet (123a) on the housing (102) to a coolant heating path outlet (123b) on the housing (102).
11. The electric compressor (100) as described in any one of the preceding embodiments, wherein the power electronics (116) are designed to operate the electric heater (120) in a heating mode and to operate the electric motor (112) in a low-efficiency mode or a high-efficiency mode, wherein the electric motor (112) generates more waste heat in the low-efficiency mode than in the high-efficiency mode.
12. The electric compressor (100) as described in embodiment 11, wherein the power electronics (116) are designed to operate the electric motor (112) in the low-efficiency mode when a temperature (T) of a coolant in the coolant heating path (123) lies below a first temperature threshold value (T1).
13. The electric compressor (100) as described in embodiment 12, wherein the power electronics (116) are designed to operate the electric motor (112) in the high-efficiency mode when the temperature (T) of the coolant reaches the first temperature threshold value (T1).
14. The electric compressor (100) as described in either one of claims 12 and 13, wherein the power electronics (116) are designed to stop the operation of the electric heater (120) when the temperature of the coolant reaches a second temperature threshold value (T2), the second temperature threshold value (T2) corresponding to an operating temperature (Tdef) of the vehicle battery (22) and being higher than the first temperature threshold value (T1).
15. The electric compressor (100) as described in any one of the preceding embodiments, wherein the electric heater (120) is a high-voltage heater which can be operated with voltages of at least 240 V.
16. The electric compressor (100) as described in any one of the preceding embodiments, wherein the electric motor (112) is a high-voltage electric motor which can be operated with voltages of at least 240 V.
17. A thermal management system (1) for an automotive application with a vehicle battery (22), comprising:
   an electric compressor (100) as described in any one of the preceding embodiments,
   a coolant circuit (20) in which the vehicle battery (22) is located, wherein the coolant heating path (123) is located in the coolant circuit (20), the coolant circuit (20) comprising a pump (24) which can be used to circulate coolant through the coolant circuit (20) during operation,
   a refrigerant circuit (30), wherein the refrigerant path (111) is located in the refrigerant circuit (30), wherein the electric compressor (100) can be used to circulate refrigerant through the refrigerant circuit (30) during operation, and
   a refrigerant/coolant heat exchanger (40) via which the coolant circuit (20) and the refrigerant circuit (30) are thermally coupled.
18. The thermal management system (1) as described in embodiment 17, wherein the coolant heating path (123) can be fluidically decoupled from the coolant circuit (20) switchably via a heater inlet valve (121).
19. The thermal management system (1) as described in either one of embodiments 17 and 18, wherein the coolant circuit (20) is designed to control the temperature of the vehicle battery (22).
20. The thermal management system (1) as described in any one of embodiments 17 to 19, wherein the refrigerant circuit (30) comprises an internal heat exchanger (32), an expansion device (34), an external heat exchanger (36) and a switching device (38).
21. The thermal management system (1) as described in embodiment 20, wherein the internal heat exchanger (32) can be thermally coupled to a vehicle interior of the automotive application in order to control the temperature of the vehicle interior.
22. The thermal management system (1) as described in either one of embodiments 20 and 21, wherein the switching device (38) is designed to switch the refrigerant circuit (30) between a heating mode and a cooling mode.
23. The thermal management system (1) as described in any one of embodiments 17 to 22, wherein the automotive application is an electric vehicle, in particular wherein the automotive application is a passenger car, a truck or a bus.
24. A method (200) for operating a thermal management system (1) as described in any one of embodiments 17 to 23, wherein, when a temperature (Tb) of the vehicle battery (22) is lower than a predefined operating temperature (Tdef), the thermal management system (1) is operated in a heating mode and the method (200) comprises:
   determining (210) a temperature (T) of the coolant in the coolant circuit (20);
   operating (220) the thermal management system (1) in a first heating mode when the temperature (T) of the coolant lies below a first temperature threshold value (T1), the first heating mode (220) comprising:
      operating (222) the coolant circuit (20) so that coolant flows through the vehicle battery (22) and the coolant heating path (123),
      operating (224) the electric heater (120), and
      operating (226) the electric motor (112) in a low-efficiency mode;
   operating (230) the thermal management system (1) in a second heating mode when the temperature (T) of the coolant reaches the first temperature threshold value (T1), the second heating mode comprising:
      operating (222) the coolant circuit (20) so that coolant flows through the vehicle battery (22) and the coolant heating path (123),
      operating (224) the electric heater (120),
      operating (232) the electric motor (112) in a high-efficiency mode;
   ending (240) the heating mode when the temperature (T) of the coolant reaches a second temperature threshold value (T2), the second temperature threshold value (T2) corresponding to the operating temperature (Tdef) of the vehicle battery (22) and being higher than the first temperature threshold value (T1).
25. The method (200) as described in embodiment 24, wherein the determining (210) of the temperature (T) of the coolant is carried out at predetermined time intervals.
26. The method (200) as described in either one of embodiments 24 and 25, wherein the thermal management system (1) is operated in a normal mode (250), which is either a heating mode or a cooling mode, after the ending (240) of the heating mode.
27. The method (200) as described in embodiment 26, wherein the electric heater (120) is not operated in normal mode.
28. The method (200) as described in either one of embodiments 26 and 27, wherein the normal mode is switched (252) to the heating mode when the temperature (Tb) of the vehicle battery (22) is lower than the predefined operating temperature (Tdef).

### List of Reference Signs

1, 1a Thermal management system
10a Electric compressor
12a Electric heater
20, 20a Coolant circuit
22 Vehicle battery
24 Pump
26 Radiator
27 3-way radiator valve
30, 30a Refrigerant circuit
32 Internal heat exchanger
34 Expansion device
36 External heat exchanger
38 Switching device
40 Refrigerant/coolant heat exchanger
41 Coolant inlet valve
42 Coolant outlet valve
43 Refrigerant inlet valve
44 Refrigerant outlet valve
100 Electric compressor with integrated heater
102 Housing
110 Compressor components
111 Refrigerant path
111a Refrigerant path inlet
111b Refrigerant path outlet
112 Electric motor
114 Compressor wheel
116 Power electronics
120 Electric heater
121 Heater inlet valve
122 Heater outlet valve
123 Coolant heating path
123a Coolant heating path inlet
123b Coolant heating path outlet

1. An electric compressor (100) for a thermal management system (1) of an automotive application with a vehicle battery, comprising:
a housing (102);
an electric motor (112), a compressor wheel (114) and power electronics (116), which are located in the housing (102), the power electronics (116) being designed to control the electric motor (112) for the purpose of driving the compressor wheel (114);
a refrigerant path (111), which extends through the housing (102) and is fluidically connected to the compressor wheel (114), wherein the refrigerant path (111) can be fluidically connected to a refrigerant circuit (30) of the thermal management system (1),
a coolant heating path (123), which extends through the housing (102) and can be fluidically connected to a coolant circuit (20) of the thermal management system (1), and
an electric heater (120), which is located in the housing (102) and is thermally coupled to the coolant heating path (123),
wherein the electric heater (120) is electrically integrated in the power electronics (116) of the electric compressor (100).

2. The electric compressor (100) as claimed in claim 1, wherein the coolant heating path (123) is thermally coupled to at least one of the electric motor (112) and the power electronics (116).

3. The electric compressor (100) as claimed in claim 2, wherein the coolant heating path (123) is arranged and designed in such a way that the power electronics (116), the electric motor (112) and the electric heater (120) are thermally coupled to the coolant heating path (123) one after another in the flow direction.

4. The electric compressor (100) as claimed in claim 1, wherein the refrigerant path (111) is thermally coupled to at least one of the electric motor (112), the power electronics (116) and the electric heater (120).

5. The electric compressor (100) as claimed in claim 4, wherein the refrigerant path (111) is arranged and designed in such a way that the power electronics (116), the electric motor (112) and the electric heater (120) are thermally coupled to the refrigerant path (111) one after another in the flow direction, the compressor wheel (114) being arranged upstream or downstream of the electric heater (120) in the refrigerant path (111) in the flow direction.

6. The electric compressor (100) as claimed in claim 1, wherein the power electronics (116) are designed to operate the electric heater (120) in a heating mode and to operate the electric motor (112) in a low-efficiency mode or a high-efficiency mode, wherein the electric motor (112) generates more waste heat in the low-efficiency mode than in the high-efficiency mode.

7. The electric compressor (100) as claimed in claim 6, wherein the power electronics (116) are designed to operate the electric motor (112) in the low-efficiency mode when a temperature (T) of a coolant in the coolant heating path (123) lies below a first temperature threshold value (T1).

8. The electric compressor (100) as claimed in claim 7, wherein the power electronics (116) are designed to operate the electric motor (112) in the high-efficiency mode when the temperature (T) of the coolant reaches the first temperature threshold value (T1).

9. The electric compressor (100) as claimed in claim 7, wherein the power electronics (116) are designed to stop the operation of the electric heater (120) when the temperature of the coolant reaches a second temperature threshold value (T2), the second temperature threshold value (T2) corresponding to an operating temperature (Tdef) of the vehicle battery (22) and being higher than the first temperature threshold value (T1).

10. A thermal management system (1) for an automotive application with a vehicle battery (22), comprising:
an electric compressor (100) as described in claim 1,
a coolant circuit (20) in which the vehicle battery (22) is located, wherein the coolant heating path (123) is located in the coolant circuit (20), the coolant circuit (20) comprising a pump (24) which can be used to circulate coolant through the coolant circuit (20) during operation,
a refrigerant circuit (30), wherein the refrigerant path (111) is located in the refrigerant circuit (30), wherein the electric compressor (100) can be used to circulate refrigerant through the refrigerant circuit (30) during operation, and
a refrigerant/coolant heat exchanger (40) via which the coolant circuit (20) and the refrigerant circuit (30) are thermally coupled.

11. The thermal management system (1) as claimed in claim 10, wherein the refrigerant circuit (30) comprises an internal heat exchanger (32), an expansion device (34), an external heat exchanger (36) and a switching device (38).

12. The thermal management system (1) as claimed in claim 11, wherein the internal heat exchanger (32) can be thermally coupled to a vehicle interior of the automotive application in order to control the temperature of the vehicle interior.

13. The thermal management system (1) as claimed in claim 11, wherein the switching device (38) is designed to switch the refrigerant circuit (30) between a heating mode and a cooling mode.

14. A method (200) for operating a thermal management system (1) as claimed in claim 10, wherein, when a temperature (Tb) of the vehicle battery (22) is lower than a predefined operating temperature (Tdef), the thermal management system (1) is operated in a heating mode and the method (200) comprises:
determining (210) a temperature (T) of the coolant in the coolant circuit (20);
operating (220) the thermal management system (1) in a first heating mode when the temperature of the coolant lies below a first temperature threshold value (T1), the first heating mode (220) comprising:
operating (222) the coolant circuit (20) so that coolant flows through the vehicle battery (22) and the coolant heating path (123),
operating (224) the electric heater (120), and
operating (226) the electric motor (112) in a low-efficiency mode;
operating (230) the thermal management system (1) in a second heating mode when the temperature of the coolant reaches the first temperature threshold value (T1), the second heating mode comprising:
operating (222) the coolant circuit (20) so that coolant flows through the vehicle battery (22) and the coolant heating path (123),
operating (224) the electric heater (120),
operating (232) the electric motor (112) in a high-efficiency mode;
ending (240) the heating mode when the temperature of the coolant reaches a second temperature threshold value (T2), the second temperature threshold value (T2) corresponding to the operating temperature (Tdef) of the vehicle battery (22) and being higher than the first temperature threshold value (T1).

15. The method (200) as claimed in claim 14, wherein the thermal management system (1) is operated in a normal mode (250), which is either a heating mode or a cooling mode, after the ending (240) of the heating mode.
